(19) United States
(12) Patent Application Publication
(10) Pub. No.: US 2013/0065449 A1
(43) Pub. Date: Mar. 14, 2013

(54) CHARGER

(71) Applicants: LEI GAO, Dong-Guan (CN); BING-TAO YANG, Gong-Guan (CN); YIN-LUNG WU, New Taipei City (TW); MING-CHIANG CHEN, New Taipei City (TW)

(72) Inventors: LEI GAO, Dong-Guan (CN); BING-TAO YANG, Gong-Guan (CN); YIN-LUNG WU, New Taipei City (TW); MING-CHIANG CHEN, New Taipei City (TW)

(73) Assignee: Cheng Uei Precision Industry Co., LTD., New Taipei City (TW)

(21) Appl. No.: 13/232,943

(22) Filed: Sep. 14, 2011

(51) Int. Cl. H01R 33/00

(52) U.S. Cl. 439/660

(57) ABSTRACT

A charger includes a female connector disposed in a mobile phone, and a male connector mated with the female connector and adapter for electrically connecting with an external power supply. The female connector includes an insulating housing defining a receiving chamber, and electrical terminals partially embedded in the insulating housing with one end thereof being exposed in the receiving chamber and the other end thereof projecting out of the insulating housing to be electrically connected with a printed circuit board of the mobile phone. The male connector has electrical contacts exposed outward. The male connector can be removably inserted in the receiving chamber of the female connector to realize an electrical connection between the electrical contacts and the corresponding electrical terminals.

### BACKGROUND OF THE INVENTION

1. Field of the Invention

The present invention relates to a charger, and more particularly to a charger for a mobile phone, which is easy to carry for the convenience of charging the mobile phone.

2. The Related Art

At present, with the development of the telecommunications industry, mobile phones have brought great convenience for people's life and work. However, after using the mobile phones for a period of time, they need charging. Generally, there are two manners for charging the mobile phones. The first charging manner for the mobile phone is realized by a data cable connecting the mobile phone and a charger plug capable of connecting with a power supply. However, it results in an inconvenient trip on account of needing to simultaneously take the data cable and the charger plug during the trip of a user. The second charging manner for the mobile phone is realized by dismounting a battery from the mobile phone and then utilizing a charger to charge the battery, so that results in a complicated charging operation and an unavailability of the mobile phone during charging the battery. So, a charger capable of overcoming the above-mentioned problems is demanded.

### SUMMARY OF THE INVENTION

An object of the present invention is to provide a charger for a mobile phone. The charger includes a female connector disposed in the mobile phone, and a male connector mated with the female connector and adapter for electrically connecting with an external power supply. The female connector includes an insulating housing defining a receiving chamber, and electrical terminals partially embedded in the insulating housing with one end thereof being exposed in the receiving chamber and the other end thereof projecting out of the insulating housing to be electrically connected with a printed circuit board of the mobile phone. The male connector has electrical contacts exposed outward. The male connector can be removably inserted in the receiving chamber of the female connector to realize an electrical connection between the electrical contacts and the corresponding electrical terminals.

As described above, the charger of the present invention includes the female connector disposed in the mobile phone and the male connector adapter to be connected with the power supply. When the mobile phone needs to be charged, directly place the mobile phone onto the male connector to realize the electrical connection between the female connector and the male connector. So, the charge for the mobile phone can be directly achieved without the data cable and the process of dismounting a battery from the mobile phone in the prior art, so that realizes the convenience of taking the mobile phone and charging the mobile phone during the trip.

### BRIEF DESCRIPTION OF THE DRAWINGS

The present invention will be apparent to those skilled in the art by reading the following description, with reference to the attached drawings, in which:

FIG. 1 is a perspective view of a charger in accordance with an embodiment of the present invention, wherein a female connector and a male connector are engaged with each other;

FIG. 2 is a perspective view of the charger of FIG. 1, showing that the female connector is disengaged from the male connector;

FIG. 3 is another angle of perspective view of the charger of FIG. 2;

FIG. 4 is an exposed view of the female connector of the charger of FIG. 1;

FIG. 5 is a perspective view of an electrical terminal of the female connector of FIG. 4;

FIG. 6 is a lateral view of the charger of FIG. 1; and

FIG. 7 is a cross-sectional view of the charger of FIG. 6 along the line A-A.

### DETAILED DESCRIPTION OF THE PREFERRED EMBODIMENT

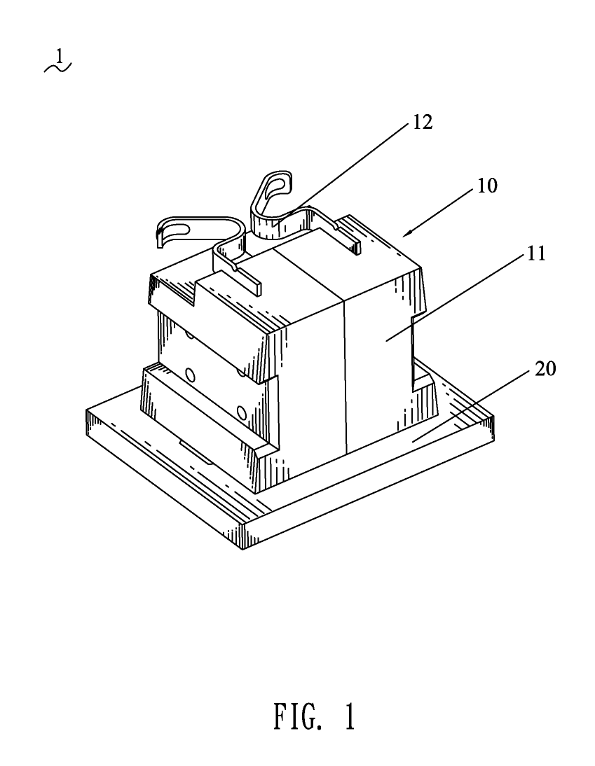

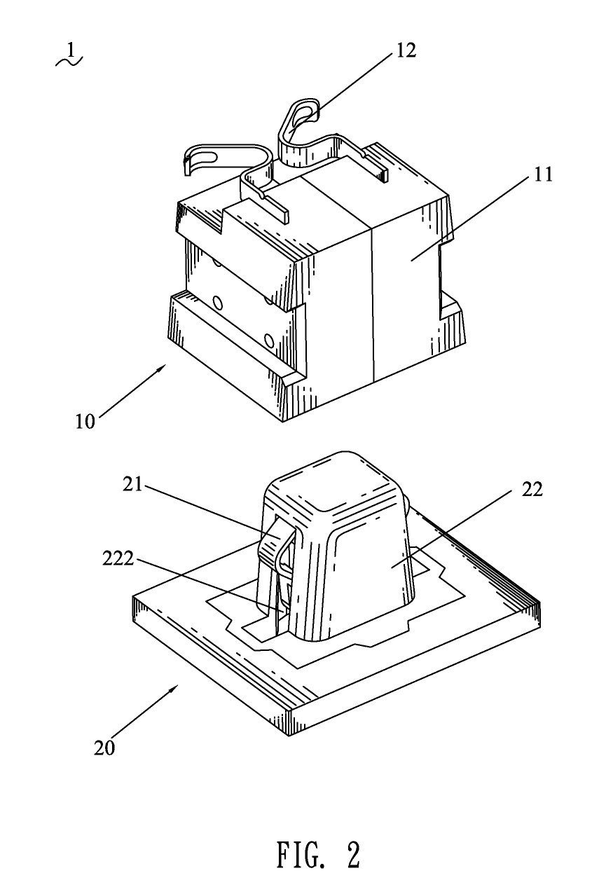

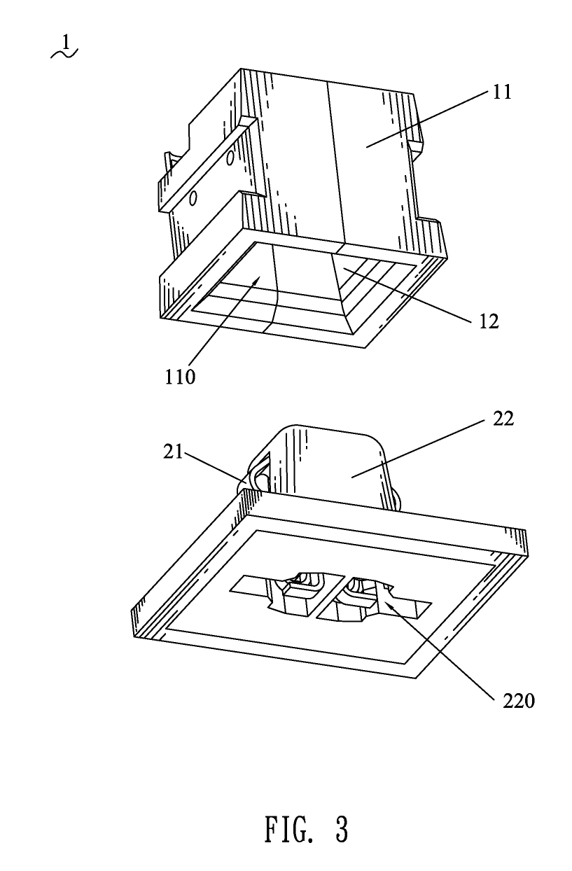

Referring to FIG. 1, FIG. 2 and FIG. 3, a charger 1 for a mobile phone (not shown) in accordance with an embodiment of the present invention includes a female connector 10 and a male connector 20 mated with the female connector 10. The female connector 10 is disposed in the mobile phone, and includes an insulating housing 11 and electrical terminals 12. The insulating housing 11 defines a receiving chamber 110 for the insertion of the male connector 20 therein. The electrical terminal 12 is partially embedded in the insulating housing 10, with one end thereof being exposed in the receiving chamber 110 and the other end thereof projecting out of the insulating housing 10 to be electrically connected with a printed circuit board (not shown) of the mobile phone. The male connector 20 is adapted for electrically connecting with an external power supply (not shown) and has electrical contacts 21 exposed outward. The male connector 20 is removably inserted in the receiving chamber 110 of the female connector 10 to realize an electrical connection between the electrical contacts 21 and the corresponding electrical terminals 12.

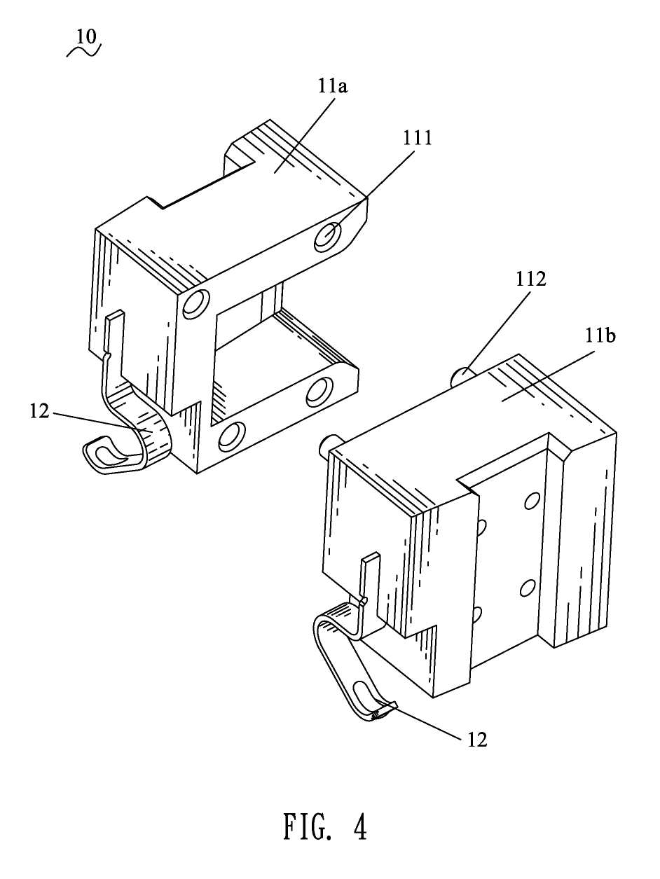

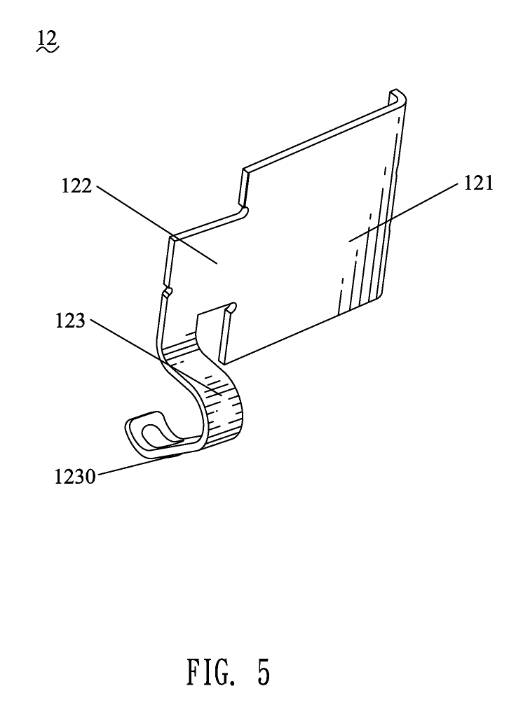

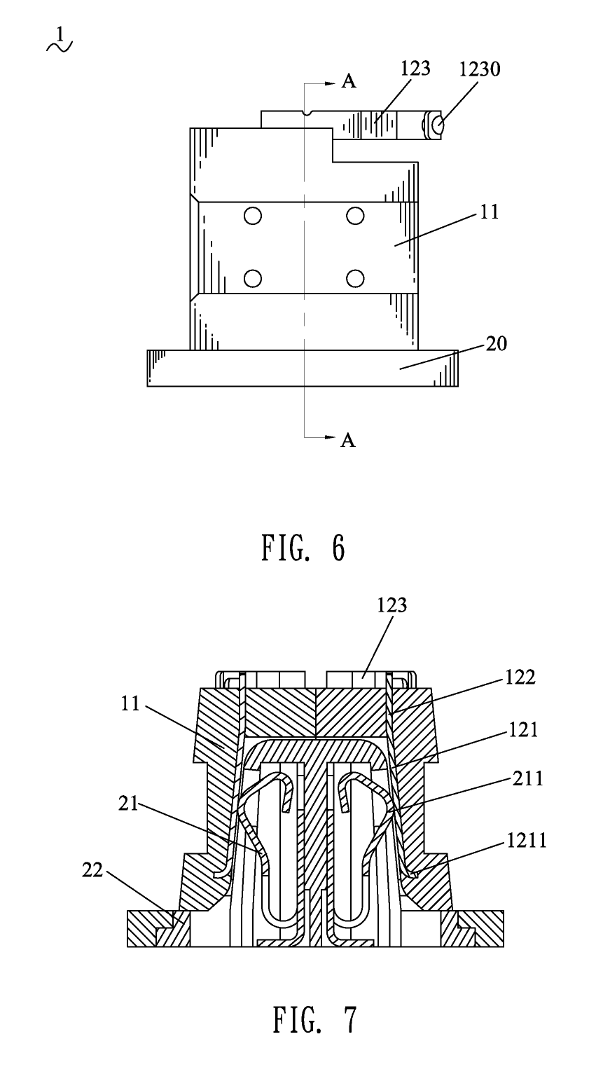

Referring to FIG. 4, FIG. 5, FIG. 6 and FIG. 7, the insulating housing 11 is composed of a first housing 11a and a second housing 11b which are butt-jointed with each other to define the receiving chamber 110 therebetween. In this embodiment, the first housing 11a has the joint face thereof abutting against the second housing 11b designed with a plurality of fastening holes 111, and accordingly, the second housing 11b has the joint face thereof abutting against the first housing 11a designed with a plurality of fastening blocks 112, which are fit in with and inserted in the fastening holes 111 respectively to realize the butt jointof the first housing 11a and the second housing 11b. The electrical terminals 12 are respectively embedded in the first housing 11a and the second housing 11b. Each of the electrical terminals 12 has a board-shaped electrical pad 121, a substantially V-shaped elastic arm 123 and a connecting portion 122 connected between one end edge of the electrical pad 121 and one end of the elastic arm 123. The connecting portions 122 of the electrical terminals 12 are respectively molded in the first housing 11a and the second housing 11b of the insulating housing 11 to make the electrical pads 121 exposed in the receiving chamber 110 and face-to-face abut against two opposite insides of the receiving chamber 110, and the elastic arms 123 stretched out of the first housing 11a and the second housing 11b for electrically connecting with the printed circuit board of the mobile phone. The other end edge of the electrical pad 121 is bent sideward to form a fastening tail 1211 molded in the corresponding inside of the receiving chamber 110. A distal end of the elastic arm 123 is designed with a contact projection 1230 thereon for electrically contacting with the printed circuit board of the mobile phone.

Referring to FIG. 2, FIG. 3 and FIG. 7, the male connector 20 includes a base body 22 defining two inserting cavities 220 therein. Two opposite outsides of the base body 22 define two openings 222 respectively communicated with the inserting cavities 220. The electrical contacts 21 are assembled in the inserting cavities 220 respectively and each has one end thereof connected with a printed circuit board (not shown) of the power supply. The other end of each electrical contact 21 is arched outward to form a contact portion 211 elastically projecting outward out of the corresponding opening 222. When the mobile phone needs to be charged, the male connector 20 is inserted into the receiving chamber 110 of the female connector 10 to make the contact portions 211 of the electrical contacts 21 electrically connect with the electrical pads 121 of the electrical terminals 12, respectively.

As described above, the charger 1 of the present invention includes the female connector 10 disposed in the mobile phone and the male connector 20 adapter to be connected with the power supply. When the mobile phone needs to be charged, directly place the mobile phone onto the male connector 20 to realize the electrical connection between the female connector 10 and the male connector 20. So, the charge for the mobile phone can be directly achieved without the data cable and the process of dismounting a battery from the mobile phone in the prior art, so that realizes the convenience of taking the mobile phone and charging the mobile phone during the trip.

What is claimed is:

1. A charger for a mobile phone, comprising:
a female connector disposed in the mobile phone, the female connector including an insulating housing defining a receiving chamber, and electrical terminals partially embedded in the insulating housing with one end thereof being exposed in the receiving chamber and the other end thereof projecting out of the insulating housing to be electrically connected with a printed circuit board of the mobile phone; and
a male connector mated with the female connector and adapter for electrically connecting with an external power supply, the male connector having electrical contacts exposed outward, wherein the male connector can be removably inserted in the receiving chamber of the female connector to realize an electrical connection between the electrical contacts and the corresponding electrical terminals.

2. The charger as claimed in claim 1, wherein the insulating housing includes a first housing and a second housing which are butt jointedwith each other to define the receiving chamber therebetween, the first housing and the second housing respectively have one of the electrical terminals embedded therein.

3. The charger as claimed in claim 2, wherein the first housing has the joint face thereof abutting against the second housing designed with a plurality of fastening holes, and accordingly, the second housing has the joint face thereof abutting against the first housing designed with a plurality of fastening blocks, which are fit in with and inserted in the fastening holes respectively to realize the butt jointof the first housing and the second housing.

4. The charger as claimed in claim 1, wherein the electrical terminal has an electrical pad, a substantially V-shaped elastic arm and a connecting portion connecting one end edge of the electrical pad and one end of the elastic arm, the connecting portions of the electrical terminals are respectively molded in the insulating housing to make the electrical pads exposed in the receiving chamber and face-to-face abut against two opposite insides of the receiving chamber, and the elastic arms stretched out of the insulating housing for electrically connecting with the printed circuit board of the mobile phone.

5. The charger as claimed in claim 4, wherein the other end edge of the electrical pad is bent sideward to form a fastening tail molded in the corresponding inside of the receiving chamber.

6. The charger as claimed in claim 1, wherein the male connector includes a base body defining two inserting cavities therein, two opposite outsides of the base body define two openings respectively communicated with the inserting cavities, the electrical contacts are assembled in the inserting cavities respectively and each has one end thereof connected with the power supply and the other end thereof elastically projecting outward out of the corresponding opening to electrically connect with the corresponding electrical terminal.
